(19) United States
(12) Patent Application Publication
(10) Pub. No.: US 2015/0293342 A1
(43) Pub. Date: Oct. 15, 2015

(54) IMAGE CAPTURING APPARATUS AND IMAGE CAPTURING METHOD

(71) Applicant: CANON KABUSHIKI KAISHA, Tokyo (JP)

(72) Inventor: Miyoko Kawashima, Tokyo (JP)

(21) Appl. No.: 14/682,521

(22) Filed: Apr. 9, 2015

(30) Foreign Application Priority Data
Apr. 11, 2014 (JP) 2014-081928

(51) Int. Cl. G02B 21/36; G01B 11/06; H04N 7/18; G01B 11/24

(52) U.S. Cl. CPC G02B 21/361; G01B 11/24; G01B 11/06; H04N 7/183

(57) ABSTRACT

An image capturing apparatus performs image capturing of an object from its surface side. The image capturing apparatus includes an image capturing optical system 304, a deformable mirror 3042 disposed in an intermediate imaging area of the image capturing optical system, a controller 400 configured to divide the object into a plurality of object areas, calculate an approximate surface approximating a surface shape of the object in each of the object areas using shape data indicating the surface shape, and deform the deformable mirror to a shape corresponding to the approximate surface.

### BACKGROUND OF THE INVENTION

1. Field of the Invention

The present invention relates to an image apparatus of, for example, a microscope for capturing an object image of a sample or the like.

2. Description of the Related Art

In a microscope for acquiring digital images by capturing of an image of a sample, such as a human tissue, an image capturing optical system with high resolution is being developed to determine a fine structure of the sample. However, higher resolution processing of an image capturing optical system generally decreases a depth of focus.

On the other hand, a surface shape of a sample is not necessarily flat, and usually has irregularities. If the thickness of a cover glass holding the sample in a prepared slide is uneven, large undulation appears in the surface shape of the sample. If the temperature near a sample changes, the focus state of an image capturing optical system may change.

As disclosed in Japanese Patent Laid-Open No. (“JP”) 2006-343573, conventional microscopes use a method for capturing images of an entire sample while moving, with respect to the sample, an image capturing optical system that has a field of view capable of capturing an image of only small areas of the sample and while adjusting the focus of an image capturing optical system with respect to each of the small areas. Therefore, the microscopes has a disadvantage that capturing time gets longer.

On the other hand, JP2009-3016 discloses a method for enabling a quick image capturing of an entire sample by enlarging the field of view of an image capturing optical system and capturing a plurality of small areas of the sample together using a plurality of image sensors.

However, in an image capturing optical system, if the resolution is increased while enlarging the field of view, the depth of focus decreases as mentioned above. Therefore, it is difficult to focus over entire field of view on a sample having a surface shape including the irregularities and the undulation.

### SUMMARY OF THE INVENTION

The present invention provides an image capturing apparatus and an image capturing method that enables image capturing with high resolution in focusing on a sample (object) over a large field of view.

An image capturing apparatus as one aspect of the present invention performs image capturing of an object from its surface side, and includes an image capturing optical system, a deformable mirror disposed in an intermediate imaging area of the image capturing optical system, and a controller configured to divide the object into a plurality of object areas, calculate an approximate surface approximating a surface shape of the object in each of the object areas using shape data indicating the surface shape, and deform the deformable mirror to a shape corresponding to the approximate surface.

A method for performing image capturing of an object from its surface side through an image capturing optical system as another aspect of the present invention includes obtaining shape data indicating a surface shape of the object, calculating an approximate surface approximating the surface shape in each object area using the shape data by dividing the object into a plurality of object areas, and capturing the image by deforming a deformable mirror to a shape corresponding to the approximate surface, the deformable mirror disposed in an intermediate image area of the image capturing optical system.

Further features of the present invention will become apparent from the following description of exemplary embodiments (with reference to the attached drawings).

### BRIEF DESCRIPTION OF THE DRAWINGS

FIG. 1 shows a configuration of a microscope system including a microscope in first embodiment of the present invention.

FIGS. 2A and 2B are flowcharts that show procedures for obtaining image data of a sample in the microscope system.

FIGS. 3A and 3B show a configuration of an image capturing optical system of the microscope system.

FIGS. 4A and 4B show a configuration of a deformable mirror included in the image capturing optical system.

FIGS. 5A to 5C show a example of an approximate quadric surface of a sample having undulation.

FIGS. 6A to 6C are tables that show simulation results in a first embodiment.

FIGS. 7A to 7C are tables that show simulation results in a second embodiment.

FIG. 8 shows an image capturing method using the microscope system.

FIG. 9 shows an example of a focus position measuring method using the microscope system.

### DESCRIPTION OF THE EMBODIMENTS

A description will now be given of embodiments according to the present invention.

### First Embodiment

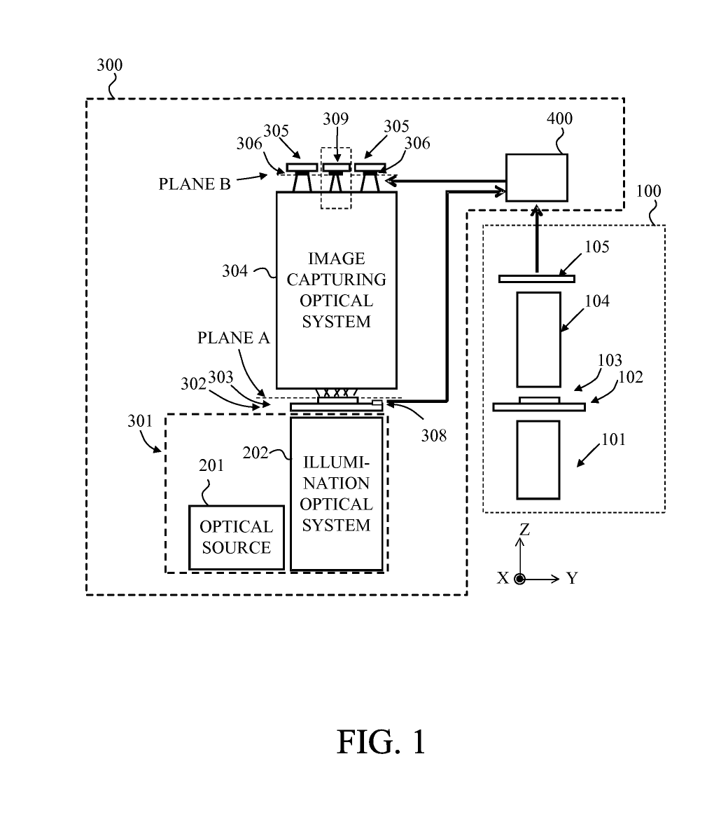

FIG. 1 shows an example of a configuration of a microscope system including a microscope as an image capturing apparatus in first embodiment of the present invention. The microscope system is configured by a measuring system 100 that measures the thickness of an after-mentioned slide glass, a surface shape of a sample or the like, and a microscope 300 that performs image capturing of the sample.

The measuring system 100 is configured by a measuring illuminator 101, a measuring stage 102, a measuring optical system 104, and a measuring part 105.

The measuring illuminator 101 includes an illumination optical system that introduces light from an optical source (not shown) to a sample as an object in a preparation 103 disposed on the measuring stage 102. The preparation 103 is configured by a slide glass, a sample, such as a tissue, that is an observation object located on the slide glass, and a cover glass overlaid on the slide glass so as to cover (protect) the sample. The measuring stage 102 holds the preparation 103, and is driven so as to adjust a position of a preparation 103 (sample) with respect to the measuring optical system 104. The measuring part 105 measures the size of the sample, the surface shape, the thickness of the cover glass, and the like by receiving through the measuring optical system 104 light that is emitted from the measuring illuminator 101 and is reflected by or passing through the preparation 103.

The measuring optical system 104 desirably has a large field of view that covers the entire sample, and the resolving power may be low. The size of the sample can be measured by a general method, such as the binarization of a luminance distribution of a sample image formed by the measuring optical system 104 or the detection of an outline of the sample image. Moreover, the surface shape of the sample may be measured using light reflected by the sample or using an interferometer. For example, a method of utilizing a triangulation method (JPH6-011341) or a method of measuring a difference of a distance of a laser light reflected by a glass interface using a confocal optical system (JP2005-98833) may be utilized. The thickness of the cover glass can be measured using a laser interferometer or the like. The measuring part 105 transmits, to a controller 400, data indicating the measurement result.

After the measurement, the preparation 103 mounted on the measuring stage 102 is conveyed on the image capturing stage 302 by adsorption, grip, or the like due to a sample conveying equipment (not shown) (hereinafter, numerical sign of the preparation is represented by 303). A configuration where the measuring stage 102 moves and functions as the image capturing stage 302 may be adapted.

The image capturing stage 302 can move in parallel to X-axis direction and Y-axis direction orthogonal to an image capturing optical axis (Z-axis direction among X-, Y-, and Z-axis directions in FIG. 1), and tilt around X axis or Y axis.

The microscope 300 performs image capturing of the sample in the preparation 103 from the surface side. The microscope 300 is configured by an image capturing illuminator 301, the above-mentioned image capturing stage 302, an image capturing optical system 304, an image capturing part 305, and a controller 400. The microscope 300 includes at least one of a temperature sensor 308 and a focus measuring part (focus measurer) 309.

The image capturing illuminator 301 includes an optical source 201, and an illumination optical system 202 that introduces, to the preparation 303 mounted on the image capturing stage 302, light emitted from the optical source 201. A halogen lamp, a xenon lamp, a LED, or the like can be used as the optical source 201. The image capturing stage 302 holds the preparation 303, and is driven so as to adjust the position of the preparation 303 with respect to the image capturing optical system 304.

The temperature sensor 308 is disposed on the image capturing stage 302 (or near the image capturing stage 302). The temperature sensor 308 measures the temperature near the preparation 303. The temperature sensor 308 may be disposed between the cover glass and the slide glass in the preparation 303 or in the image capturing optical system 304. A plurality of temperature sensors may be disposed at the above-mentioned plurality of positions.

The focus measuring part 309 measures a position of the preparation 303 in the optical axis direction of the image capturing optical system 304. In particular, the focus measuring part 309 monitors one or plural positions (specific point) arbitrarily set in the optical axis direction in the preparation 303. As a result, it is possible to detect how much the specific point in the optical axis shifts from a focus reference position of the microscope 300 (for example, best focus surface of the image capturing optical system 304), including shifts due to temperature change. Based on the shift amount and the data of the surface shape of the sample or the thickness of the cover glass, which is measured by the measuring system 100, the amount of change of focus positions over the entire preparation 303 (hereinafter referred to as “focus shift”) can be obtained.

In this embodiment, the focus measuring part 309 is disposed outside the image capturing optical system 304, but may be inside the image capturing optical system 304.

The image capturing optical system 304 forms an optical image of a sample illuminated on a plane A of the image capturing stage 302 (image captured plane) on the image capturing plane B with high resolution. The image capturing optical system 304 includes an after-mentioned deformable mirror inside.

The controller 400 calculates data of the surface shape of the sample or the thickness of the cover glass, which is measured by the measuring system 100, and the data indicating change of the temperature measured by the temperature sensor 308. The focus shift is compensated by deforming the shape of the reflection surface of the deformable mirror based on the focus shift amount.

The image capturing part 305 receives a sample image (optical image) that light reflected by or passing through the sample in the preparation 303 forms on the image capturing plane B by transmitting the image capturing optical system 304. The image capturing part 305 includes an image sensor 306 of a CCD sensor, a CMOS sensor, or the like and an electric circuit for driving the image sensor 306, and the image sensor 306 photoelectrically converts the sample image. By processing an electrical signal (imaging signal) output from the image sensor 306, image data of the sample can be obtained. The microscope 300 divides the sample into a plurality of areas (object area: hereinafter referred to as “divided sample area”), the image sensor 306 corresponding to a part of the plurality of divided sample areas is disposed along the image capturing plane B.

The focus shift that is not enough to compensate only by deformation of the reflection surface can be compensated by singly or simultaneously changing (adjusting) the position of the deformable mirror or the image sensor 306 in the optical axis direction of the image capturing optical system 304. This position adjustment amount in the optical axis direction of the deformation mirror and the image sensor 306 is referred to as focus offset amount.

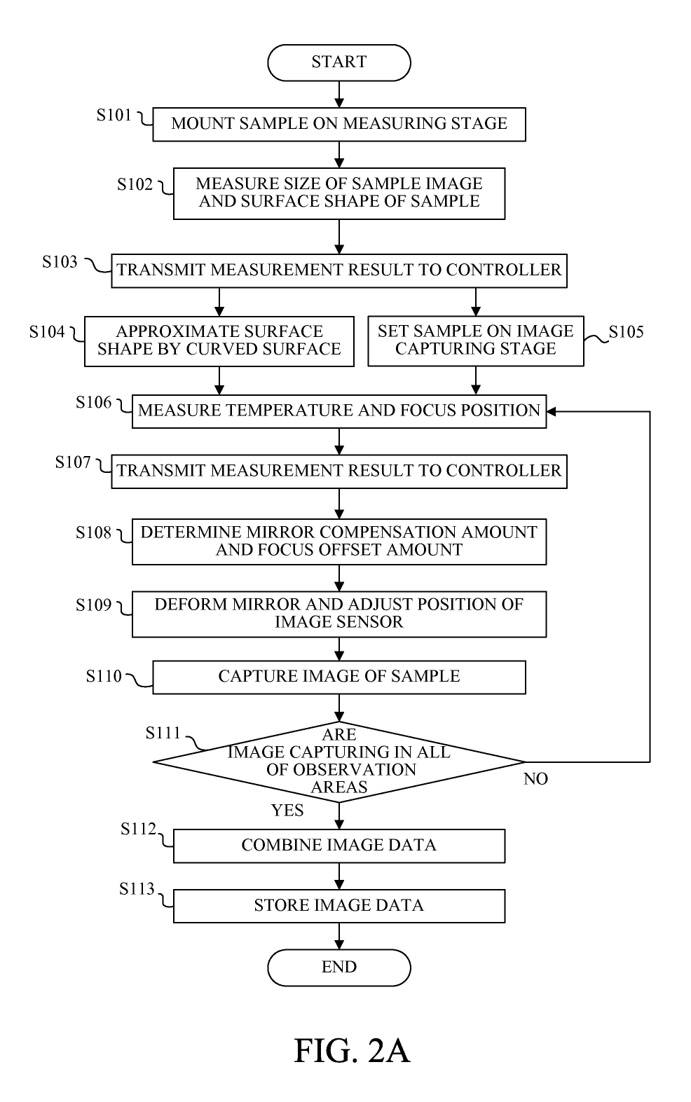

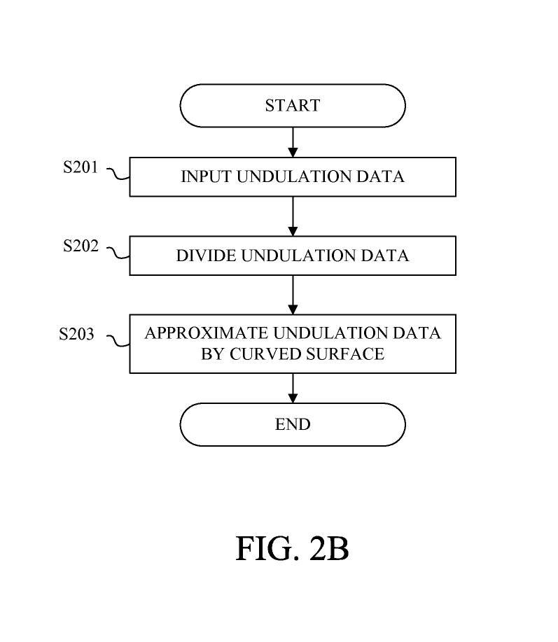

Next, a description will be given of a procedure (image capturing method) of acquiring image data of a sample with reference to a flowchart shown in FIG. 2A. First, in step S101, the preparation 103 is mounted on the measuring stage 102, the sample in the preparation 103 mounted on the measuring stage 102 is illuminated by the measuring illuminator 101.

In step S102, the measuring part 105 receives transmitted light (or reflected light) from a sample through the measuring optical system 104, and thereby the intensity of the transmitted light (or reflected light) and the position (coordinates) in the thickness direction of the sample are measured.

In step S103, the measuring part 105 transmits data indicating the measurement result (shape data) to the controller 400.

In step S104, the controller 400 calculates, using the shape data transmitted from the measuring part 105, an approximate curved surface (expression indicating the approximate curved surface) as an approximate surface approximated to the surface shape of the sample. While this approximate curved surface is calculated, in step S105, the preparation 103 is conveyed from the measuring stage 102 to the image capturing stage 302 via a sample conveying part. The image capturing stage 302 sets the sample at an image capturing position in X-axis and Y-axis directions.

In step S106, the temperature sensor 308 measures the temperature near the preparation 303 (or near the image capturing optical system 304). In addition to or instead of the temperature measurement, the focus measuring part 309 may measure a position of a specific point of the preparation 303 in the optical axis direction (focus position). In step S107, the temperature sensor 308 or (and) the focus measuring part 309 transmits data of the measured temperature or (and) the focus position to the controller 400.

In step S108, the controller 400 converts the temperature measured by the temperature sensor 308 into the focus shift amount of the entire preparation 303 by calculation. Moreover, if a focus position at a specific point is measured by the focus measuring part 309, the measured focus position is converted into the focus shift amount of the entire preparation 303 by calculation. The focus shift amount may be a uniform value regardless of the position (XY coordinate) in X-axis and Y-axis directions, and may be a value expressed by quadric function of the XY coordinate.

Next, in the same step, the controller 400 derives a new approximate curved surface by adding the focus shift amount to the coefficients of the expression of the approximate curved surface calculated in step S104. Furthermore, the controller 400 calculates a deformation amount of the reflection surface of the deformable mirror (hereinafter referred to as “mirror compensation amount”) and a focus offset amount, based on the new approximate curved surface.

In step S109, the controller 400 deforms the deformable mirror based on the mirror compensation amount. Further, the controller 400 adjusts a position of at least one of the image sensor 306 and the deformable mirror in the optical axis direction according to the focus offset amount.

In step S110, the image capturing illuminator 301 introduces illumination light to the preparation 303 (sample) on the image capturing stage 302. The image sensor 306 of each image capturing part 305 performs image capturing of a divided sample area corresponding to the image capturing part 305 in the entire sample. The image capturing part 305 transmits an image capturing signal output from the image sensor 306 to an image processing part (not shown). The image processing part generates image data by processing the image capturing signal. The image data is transmitted to a storage inside or outside the microscope 300 and is stored in it.

In step S111, the controller 400 determines whether the image capturing is performed in all of the plurality of divided sample areas. At this time, by preliminarily setting the number of times of the image capturing of all of the plurality of divided sample areas, it may be determined whether the actual number of times of the image capturing has reached the preliminarily set number of times of the image capturing. When the image capturing has not been performed in all of the plurality of divided sample areas, the controller 400 moves the image capturing stage 302 in at least one of X-axis and Y-axis directions to capture images of divided sample areas that have not been captured yet, and repeats the processings of step S106 to step S110. In other words, the controller 400 repeats the image capturing while changing the divided sample area, whose an image is captured, so as to obtain the image data of the entire sample, based on the size information of the entire sample transmitted from the measuring part 105.

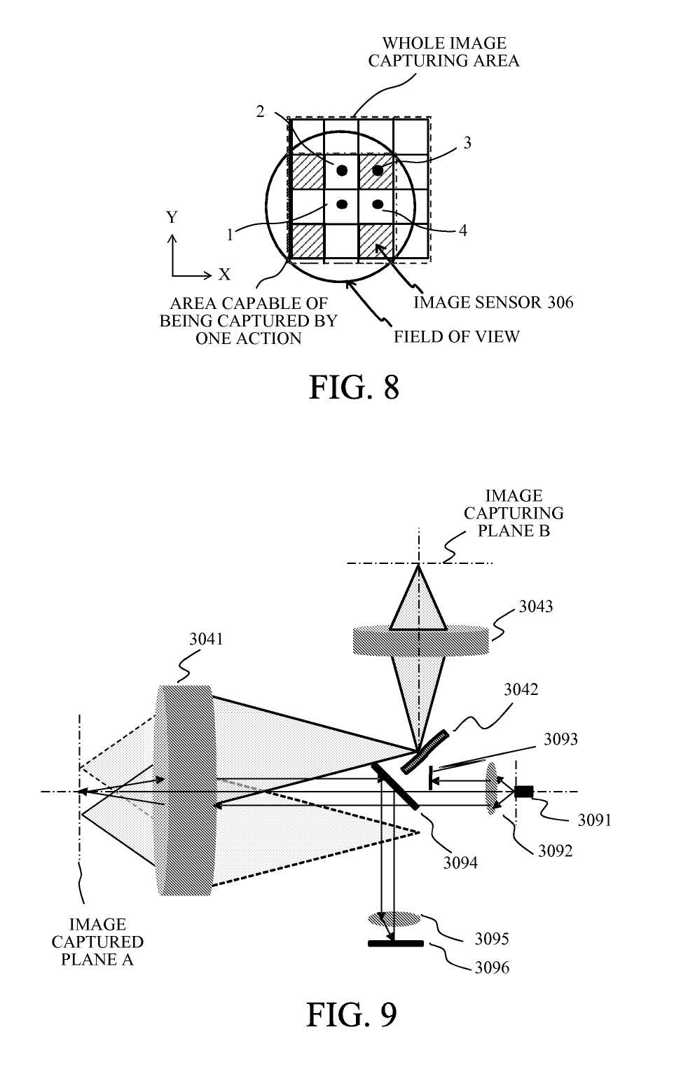

These will be described with reference to FIG. 8. FIG. 8 shows a state where four image sensors as the plurality of image sensors 306 are disposed at a space from each other in X-axis and Y-axis directions, and the width of the space equals to that of one image sensor (or divided sample area). In FIG. 8, areas of the entire sample on the image captured plane A is surrounded by dotted lines, the divided sample areas captured by each of four image sensors 306 are drawn as hatched areas. The field of view of the image capturing optical system 304 is surrounded by a circle, and the hatched areas among nine divided sample areas inscribed inside the circle and surrounded by alternate long and short dashes lines are captured by one action.

In an example of this figure, by performing the image capturing four times while changing four divided sample areas to be captured, that is to say the center of the field of view of the image capturing optical system 304, the image of the entire sample (sixteen divided sample areas) can be captured. 1 denotes the center of the field of view of the image capturing optical system 304 in first image capturing. Similarly, 2, 3, and 4 denote the centers of the fields of view of the image capturing optical system 304 in second, third, fourth image capturing.

After the image capturing in all of the plurality of divided sample areas is finished by the above method, in step S112, the controller 400 causes the image processing part to generate image data of the entire sample by combining the image data of all of the divided sample areas. The image processing part performs image processings, such as gamma correction, noise elimination, and compression, to the combined image data.

In step S113, the controller 400 causes the above-mentioned storage to store the image data of the entire sample, generated in the image processing part.

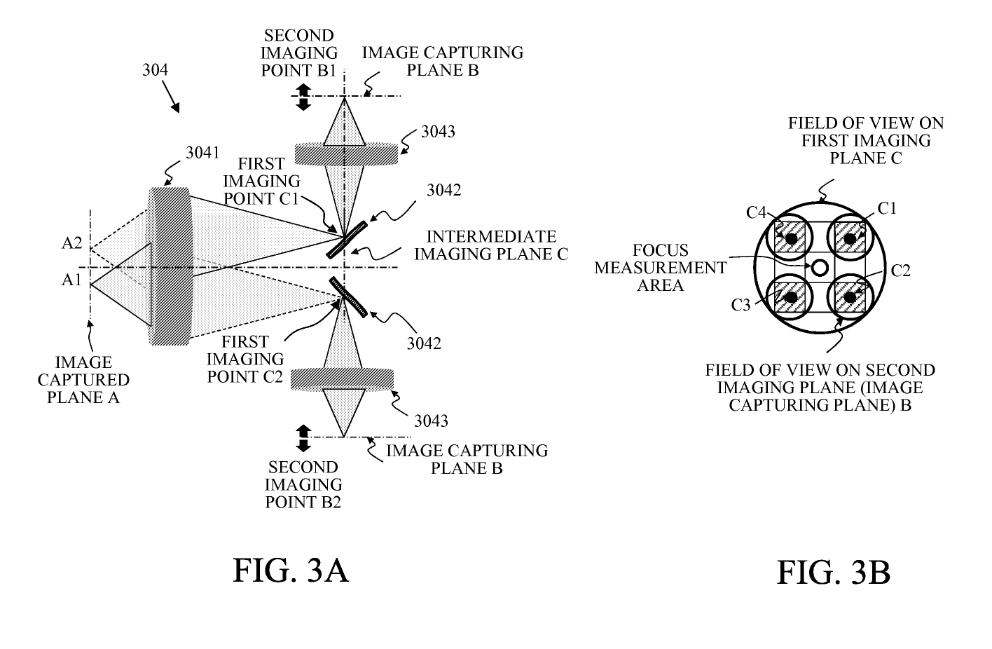

A description will be given of a configuration of the image capturing optical system 304 in detail with reference to FIG. 3A. The image capturing optical system 304 is configured by, in order from the image captured plane A (object side) to the image capturing plane B, a first imaging optical system (first optical system part) 3041, a plurality of deformable mirrors 3042, and a plurality of second imaging optical system (second optical system part) 3043. A description will be given of the image capturing optical system 304 having a high resolution and a large field of view that covers the plurality of (nine) divided sample areas as described with reference to FIG. 8.

The image capturing optical system 304 divides an imaging plane (intermediate imaging plane) C of the first imaging optical system 3041 into nine areas. An image (intermediate image) of one area among the nine areas is reimaged on the image capturing plane B by the second imaging optical system 3043. In other words, the image captured plane A, the image capturing plane B, and the intermediate imaging plane C are conjugated with each other. The other intermediate imaging plane may be located on an imaging captured plane A side further than the intermediate imaging plane C.

The same number of the deformable mirrors (hereinafter also simply referred to as mirror) 3042 as the image sensor 306 are disposed in the intermediate imaging area including the intermediate imaging plane C and the vicinity thereof. As shown in FIG. 8, in the case of setting four image sensors 306, four mirrors 3042 are disposed. The second imaging optical system 3043 is disposed with respect to each of the plurality of mirrors 3042. Namely, with respect to each of the plurality of image sensors 306, a common first imaging optical system 3041, a dedicated mirror 3042, and a dedicated second imaging optical system 3043 are disposed. FIG. 3A shows two among the plurality of (four) mirrors 3042 and the second imaging optical system 3043.

The field of view (image circle) on the intermediate imaging plane C of the first imaging optical system 3041 is represented by a large circle in FIG. 3B. Four areas represented by small circles inscribed inside the field of view correspond to the field of view on the intermediate imaging plane C of the second imaging optical system 3043. Each small circle area covers a continuous area indicated as a hatched area, that is to say an area where the intermediate image of one divided sample area is formed. Light in each small circle area is reflected by one of the four mirrors 3042, and forms an image on the image capturing plane B, which is a final imaging plane, by the second imaging optical system 3043 and enters the image sensor 306.

In FIG. 3A, light from an arbitrary point A1 in the image captured plane A transmits the first imaging optical system 3041 and images on a first imaging point (intermediate imaging point) C1. Then, the light is reflected by a mirror 3042 disposed on the intermediate imaging area including the first imaging point C1 and the vicinity thereof. The vicinity of the first imaging point C1 means that, even if a point on the mirror 3042 is located on the first imaging point C1, the mirror 3042 at an imaged height apart from the point shifts from the first imaging point C1 in the optical axis direction.

Light reflected by the mirror 3042 transmits the second imaging optical system 3043, and forms an image on a second imaging point B1 on the image capturing plane B and enters the image sensor 306.

Similarly, light from points A2, A3, A4 on the image captured plane A forms images on the first imaging points C2, C3, C4, and further forms images on the second imaging points B2, B3, B4 (however, A3, A4, B3, B4 are not shown).

FIG. 3B shows that a focus position measurement using the focus measuring part 309 is performed in a focus measurement area located at a part (non-captured area) not included in a plurality of small circle areas in the field of view of the first imaging optical system 3041, that is to say areas capable of capturing an intermediate image.

As an example of a detection method of a focus state used for the focus position measurement in the focus measuring part 309, FIG. 9 shows a focus state detection method by TTL system. This shows a method (U.S. Pat. No. 4,798,948) of detecting the focus state based on a state of reflection light that is obtained by irradiating light to an object and receiving the reflection light from the object by the light receiving element.

Light emitted from an optical source 3091 is converted into a parallel light flux by a collimate lens 3092. Half of the parallel light flux is shield by a light shielding plate 3093, and the rest enters a half mirror 3094. Light that has entered the half mirror 3094 is collected through the first imaging optical system 3041 on the image captured plane A. The light is reflected by the image captured plane A, and then enters the half mirror 3094 through a light path opposite to an incident light path across the optical axis (upper side in FIG. 3A) and is reflected by the half mirror 3094. The reflected light is collected by the imaging lens 3095 to form a point image on the light receiving element 3096. The output signal of the light receiving element 3096 indicates a state of the reflection light, and a focus state can be detected based on the output signal. A position of the image captured plane A where the detected focus state is in-focus corresponds to a focus position of the first imaging optical system 3041, that is to say the image capturing optical system 304.

In the case of performing the focus position measurement using the above method, it is particularly preferable to use non-captured area in the field of view of the first imaging optical system 3041 as an area for the focus position measurement as mentioned above. Thereby, the optical source 3091 for the focus position measurement, an optical system (collimator lens 3092, half mirror 3094, and imaging lens 3095), and the light receiving element 3096 can be easily disposed.

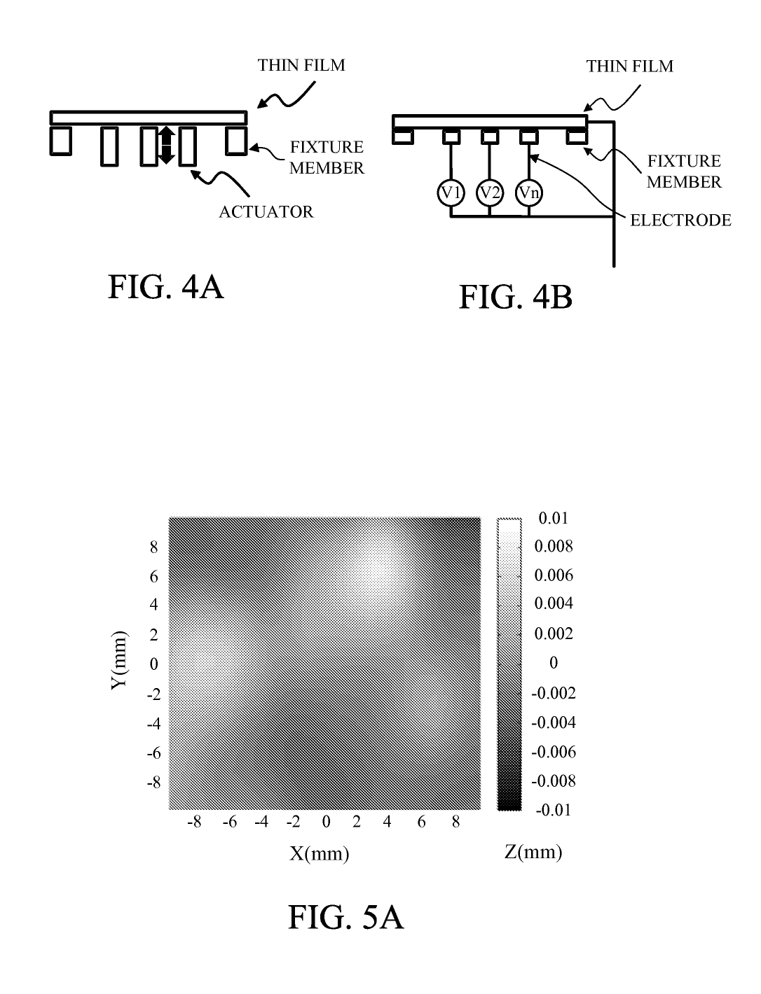

FIGS. 4A and 4B show an example of the configuration of the deformable mirror 3042. The mirror 3042 is formed by a thin film of a metal, such as aluminum, so as to provide a desired reflection characteristic. The mirror 3042 is disposed on the intermediate imaging area as shown in FIG. 3A and has a continuous reflection surface so as to prevent the information of the intermediate image from missing. The shape of the reflection surface changes the shape of a thin film by expanding and contracting actuators, such as a piezoelectric element, as shown in FIG. 4A, or changes the shape of the thin film by electrostatic attraction caused by applying the voltage between the thin film and a plurality of electrodes as shown in FIG. 4B, and thereby can be deformed. Moreover, although not shown, the reflection surface may be deformed by a method other than methods shown in FIGS. 4A and 4B, such as deforming a member (frame) holding the mirror. The initial shape of the reflection surface of the mirror 3042 may be a plane surface, a curved surface, or a spherical surface. A configuration for monitoring the deformation amount of the reflection surface of the mirror 3042 may be incorporated.

In order to control the shape configured as above of the reflection surface of the mirror 3042 configured as above, as mentioned above, the controller 400 calculates an approximate curved surface approximating the surface shape (undulation shape) of the sample using the shape data from the measuring part 105. The quadric surface as the approximate curved surface is calculated by the following expression (1).

z=B₁x²+B₂xy+B₃y²+B₄x+B₅y+B₆ (1)

Sometimes high order undulation components of third order or more is included in the surface shape of the actual sample, but it may be ignored because the amount of the undulation component of third order or more is small. The focus shift caused by the change in temperature is sufficient only by approximating low order undulation components of second order or less. Furthermore, by approximating the surface shape of the sample as quadric surface, the deformation of the reflection surface of the mirror 3042 can be easily controlled, and the number of the actuators (FIG. 4A) or the electrodes (FIG. 4B) for deforming the reflection surface can be reduced. Moreover, also in the case of monitoring the deformation amount of the reflection surface, it is sufficient just to monitor few representative points in the reflection surface.

The controller 400 deforms the reflection surface of the mirror 3042 according to the approximate curved surface of the surface shape of the sample, calculated by the above-mentioned method. In other words, the reflection surface of the mirror 3042 is deformed to a shape corresponding to the approximate curved surface. The controller 400 adjusts a position of the image sensor 306 or the mirror 3042 in the optical axis direction to compensate the focus shift.

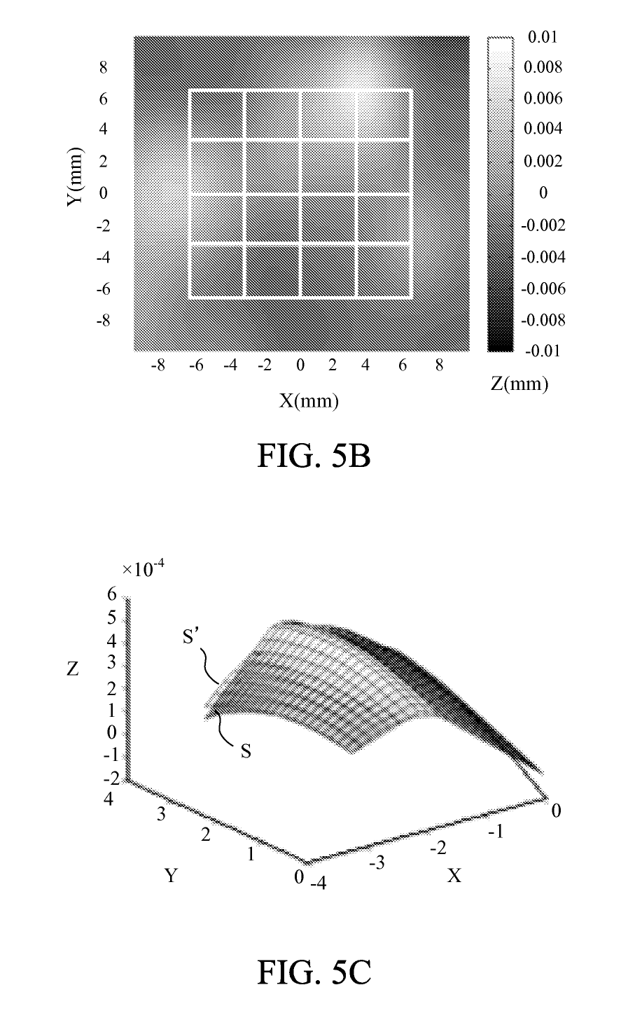

A description will be given of the calculation processing of the approximate curved surface in step S104 in the flow chart shown in FIG. 2A with reference to a flow chart of FIG. 2B. Here, a description will be given of the case where a surface shape map that is data indicating the irregularity of the surface shape of the sample as shown in FIG. 5A is provided (generated) as the above-mentioned shape data by the measuring part 105. A vertical axis and a horizontal axis of the surface shape map respectively indicates the distance from the origin in X-axis direction and Y-axis direction, that is to say a position (coordinate), and the unit is mm. A scale bar in FIG. 5A indicates a height position (coordinate) in the optical axis direction, which is Z-axis direction, the unit is mm. As will be noted from this surface shape map, the irregularity of the surface shape of the sample is ±6 μm or more. On the other hand, the depth of focus of the image capturing optical system 304 is about fpm or less, and therefore the irregularity is very large compared to the depth of focus.

In step S201, the controller 400 obtains the surface shape map, where the height position (Z position) to each XY coordinate is expressed in (X, Y, Z) form, using the measuring part 105.

In step S202, the controller 400, as shown in FIG. 5B, divides the obtained surface shape map into the same number as that of the above-mentioned plurality of divided sample areas so as to have a similar shape (scaled shape), that is to say a shape similar (scaled) to the image sensor 306. The white lines of the grating shape in FIG. 5B are dividing lines, and one divided area of the surface shape map is referred to as a “divided map area” below.

The size of each divided sample area on the sample is the size of the image sensor 306 divided by the magnification of the image capturing optical system 304. For example, if the magnification m₁ of the first imaging optical system is 5 and the magnification m₂ of the second imaging optical system is 2, the magnification of the whole image capturing optical system 304 is 10. If the image sensor 306 is a square whose one side is 32.5 mm, the length of one side of each divided sample area on the sample is 32.5 mm/10=3.25 mm. The field of view of the first imaging optical system 3041 on the side of the image captured plane A is circular and the diameter is 14.1 mm, and the length of one side of the square inscribed inside the field of view is 10 mm. On the other hand, the field of view of the second imaging optical system 3043 on the side of the image captured plane A is circular and the diameter is 4.6 mm, and the length of one side of the square inscribed inside the field of view is 3.25 mm.

The Z position to XY coordinate (xⱼ, yⱼ) in each divided map area is represented by (xⱼ, yⱼ, zⱼ). In step S203, the controller 400 calculates a quadric surface approximating the surface shape of the sample. At this time, a quadric surface that is approximating the surface shape in each of the divided sample areas (area number is represented by i) and is indicated by the following expression (1′) is calculated by the least-squares method using Z position data of the divided map area corresponding to the divided sample area.

z=B₁(i)x²+B₂(i)xy+B₃(i)y²+B₄(i)x+B₅(i)y+B₆(i) (1′)

where i=1, 2, 3, . . . , iₙ is satisfied.

The coefficients B₁(i),B₂(i), . . . ,B₆(i) are calculated in each of all of the divided sample areas.

In FIG. 5C, a surface shape S having undulation in a divided sample area and a quadric surface S′ approximate hereto and calculated by the least-squares method are shown three-dimensionally.

Next, a description will be given of a process of determining the mirror compensation amount and the focus offset amount in step S108 of the flow chart in FIG. 2A in detail.

The controller 400, as mentioned above, converts the temperature input in step S107 into the focus shift amount of the entire sample by calculation. Alternatively, the controller 400 converts a focus position of a specific point of the sample measured by the focus measuring part 309 into the focus shift amount of the entire sample, by calculation. These focus shift amounts may be an even value in XY coordinate, or may be values represented by the quadratic function regardless of XY coordinate.

The controller 400 adds the focus shift amounts to the coefficient of the approximate curved surface obtained in step S104, and calculates a new approximate curved surface. If the focus shift amounts are an even value regardless of XY coordinate, it is required to merely add the value to only a constant term of the approximate curved surface. Moreover, if the focus shift amounts are values represented by the quadratic function in XY coordinate, it is required to merely respectively add the values to the coefficients of terms corresponding to the approximate curved surface (quadric surface).

The controller 400 calculates the mirror compensation amount and the focus offset amount from the expression of the approximate curved surface that is newly obtained. In particular, as mentioned below, it calculates the mirror compensation amount from terms other than the constant term of the expression of the approximate curved surface, and calculates the focus offset amount from the constant term.

The mirror compensation is half of B₁(i) x²+B₂ (i) xy+B₃ (i) y²+B₄ (i) x+B₆ (i) y. The deformation amount (actual mirror deformation amount) of the reflection surface of the actual mirror 3042 is an amount obtained considering longitudinal magnification m₁² obtained from the magnification m₁ of the first imaging optical system 3041. Namely, the actual mirror compensation amount zmⱼ at sample points j=1, . . . , nⱼ in the divided sample area i is calculated from an approximate quadric surface as the following expression (2).

zmⱼ={B₁(i)xⱼ²+B₂(i)xⱼyⱼ+B₃(i)yⱼ²+B₄(i)xⱼ+B₅(i)yⱼ}·m₁²/2 (2)

Next, the controller 400 calculates the focus offset amount with respect to the divided sample area i.

fs(i)=B₆(i)·(m₁m₂)² (3)

The focus offset amount is calculated using B₆(i) calculated by expression (1). The focus offset amount fs(i) of the image sensor 306 when only an image sensor 306 is moved in the optical axis direction is calculated by the following method. On the image capturing plane B, the magnification of the entire image capturing optical system 304 is calculated as (m₁m₂) from the magnification m₁ of the first imaging optical system 3041 and the magnification m₂ of the second imaging optical system 3043. On an image capturing plane B, the change amount of the focus position on the image captured plane A is an amount multiplied by the lateral magnification of the image capturing optical system 304 in a direction orthogonal to the optical axis, and is an amount multiplied by the longitudinal magnification of the image capturing optical system 304 in a direction parallel to the optical axis, and in other words the change amount is an amount multiplied by the square of the magnification. Accordingly, in the optical axis direction, as shown in the following expression (3), an amount where B₆(i) is multiplied by (m₁m₂)² is the focus offset amount fs(i) of the image sensor 306.

fs(i)=B₆(i)·(m₁m₂)² (3)

On the other hand, the focus offset amount fm(i) of the mirror 3042 when only the mirror 3042 is moved in the optical axis direction satisfies the following expression (4).

fm(i)=B₆(i)·m₁²/2 (4)

In the case that both of the image sensor 306 and the mirror 3042 are moved in the optical axis direction by independently controlling the focus offset amounts of the image sensor 306 and the mirror 3042, these focus offset amounts fs(i), fm(i) may be determined so as to satisfy the following expression (5).

B₆(i)=fs(i)/(m₁m₂)²+2fm(i)/m₁² (5)

A configuration where the second imaging optical system 3043 is moved in a direction orthogonal to the optical axis of the second imaging optical system 3043 along with the movement of the mirror 3042 may be incorporated.

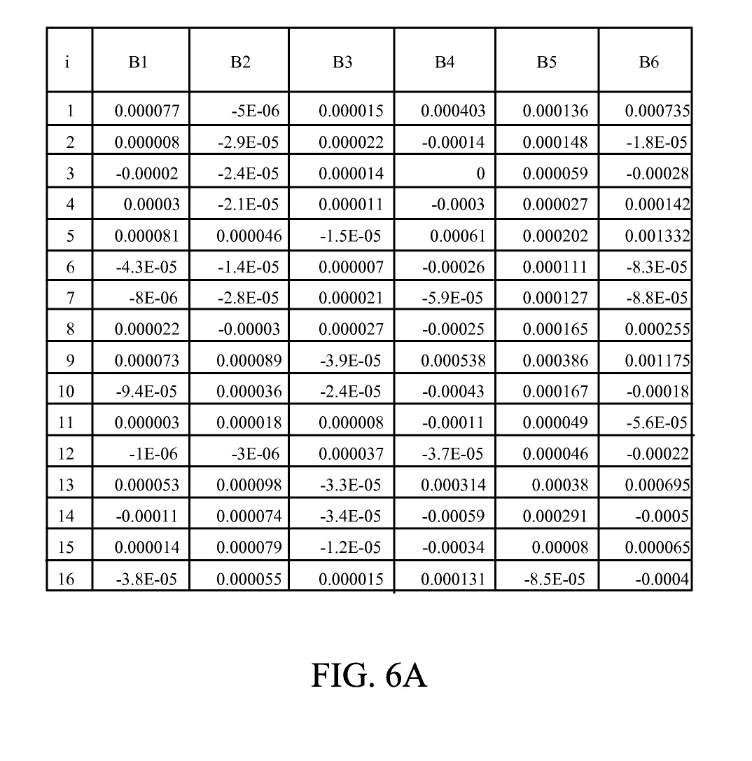

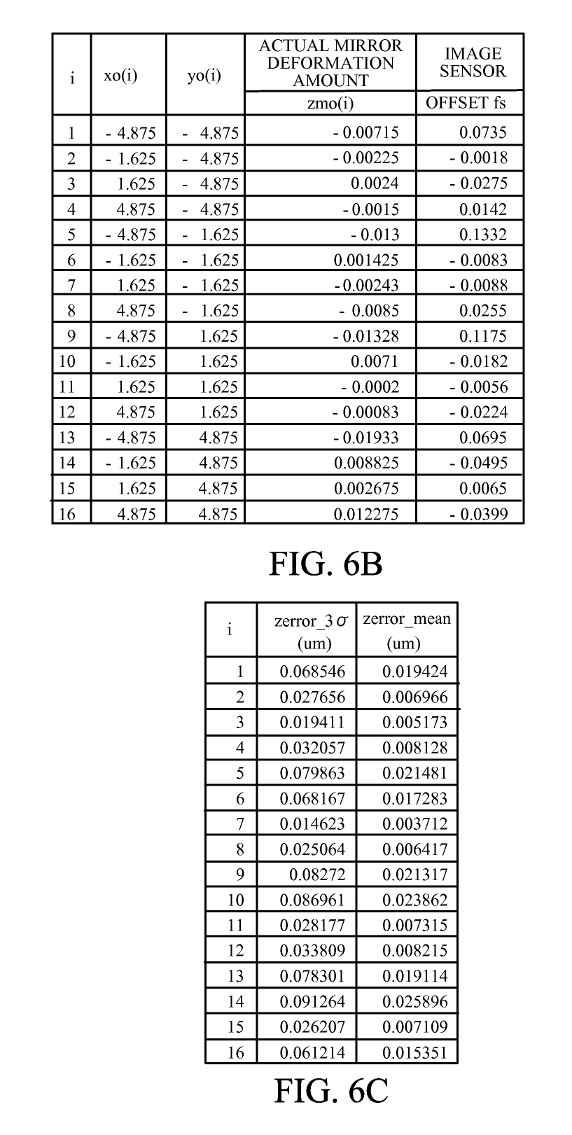

FIG. 6A shows the coefficients when the approximate quadric surface to the divided sample area i is calculated in the case where there is the undulation as shown in FIG. 5A in a surface shape of a sample. The coefficient B₆ denotes a focus offset amount (mm) on the image captured plane A.

FIG. 6B shows results where the focus offset amount fs(i) on the image capturing plane B of the image sensor 306 and the actual mirror deformation amount zm in the center position (xₒ(i), yₒ(i)) of the mirror 3042 are calculated for the divided sample area i. Actually, the actual mirror deformation amount is calculated for not only the center position of the mirror 3042 but also all positions where the actuators or the electrodes for deforming the mirror 3042 are disposed. The unit of measurements in FIG. 6B is mm.

FIG. 6C shows results where the average Zerror_mean of the correction residual error Zerror and the standard score 6 are calculated in each divided sample area. The unit of measurements in FIG. 6C is mm.

The correction residual error Zerror in XY coordinate (xⱼ,yⱼ) in each divided map area is calculated using the focus offset amounts fs(i), fm(i) and the actual mirror deformation amount zmⱼ by the following expression (6). This correction residual error is converted into the amount on the sample (image captured plane A) by calculation.

Zerror=({zⱼ−[2(zmⱼ+fm(i))/m₁²+fs(i)/(m₁m₂)²]}²)^{1/2} (6)

In addition, the magnifications of the first and second imaging optical systems 3041, 3043 used when calculating the results shown in FIG. 6C are respectively m₁=5, m₂=2. NA (numerical aperture) of the image capturing optical system 304 is 0.7, and the depth of focus is about ±0.5 μm.

The average and the value of 36 of the standard score σ of the correction residual error are very small amount, and are restrained within the depth of focus.

In this embodiment, the reflection surface of the deformable mirror 3042 is deformed based on the approximate curved surface of a surface shape (undulation shape) of a sample, and thereby the image capturing can be performed in a state where all points on the surface of the sample are contained within the depth of focus of the image capturing optical system 304.

### Second Embodiment

Next, as second embodiment of the present invention, a description will be given of a case using a plane surface as an approximate curved surface approximating a surface shape of a sample. If B1=B2=B3=0 is satisfied in the expression (1) of first embodiment, the surface shape of the sample is approximated as a plane surface.

When the surface shape is approximated as a plane surface, the actual mirror deformation amount zmⱼ is an amount to which the inclination of the plane surface is adjusted by the expression (2). The inclination on the mirror 3042 is an amount where the inclination of the sample is multiplied by (the longitudinal magnification of the first imaging optical system 3041)/(lateral magnification), and therefore the magnification is (m₁)²/m₁=m₁. The actual inclination amount of the mirror 3042 is half of its magnification. The focus offset amount is calculated using the expressions (3) to (5) explained in first embodiment.

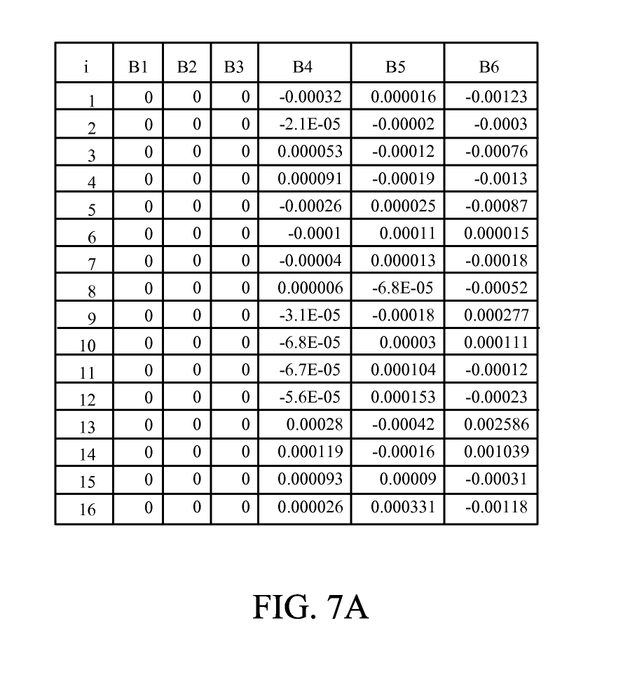

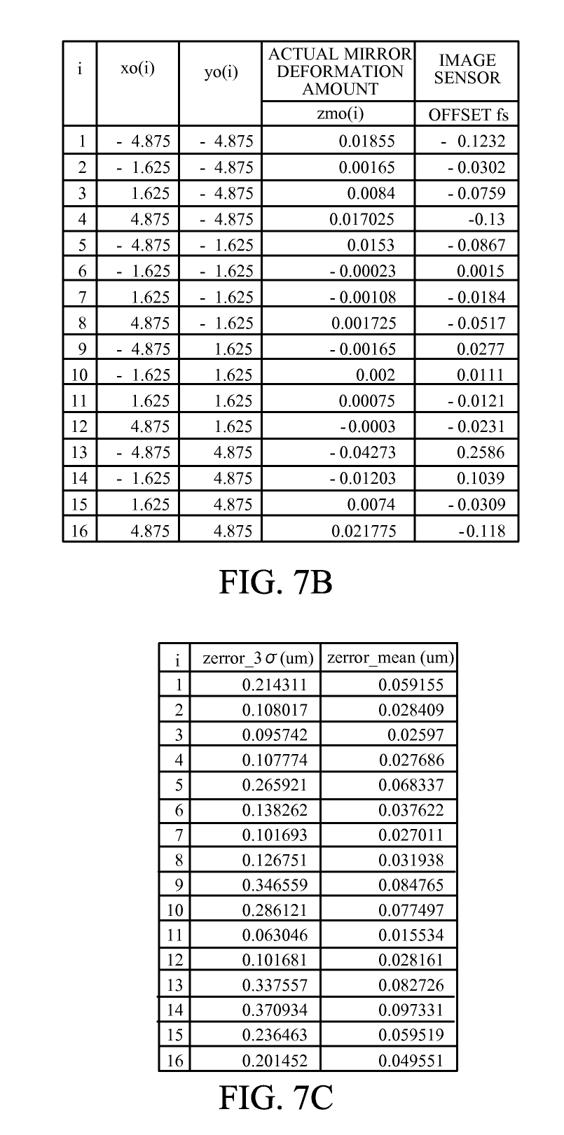

Under the same conditions as first embodiment, an approximate plane surface is calculated for the divided sample area i in the case where there is the undulation shown in FIG. 5A in a surface shape of a sample, and FIG. 7A shows the calculation results of the coefficients of the approximate plane. Since the inclination is small, the coefficients B₄, B₅ can be respectively regarded as the inclination (rad) in X-axis direction and the inclination (rad) in Y-axis direction. The coefficient B₆ means the focus offset amount f (mm) on the image captured plane A.

FIG. 7B shows results where the focus offset amount fs(i) on the image capturing plane B of the image sensor 306 and the actual mirror deformation amount zm in the center position (xₒ(i), yₒ(i)) of the mirror 3042 are calculated for the divided sample area i. Actually, the actual mirror deformation amount is calculated for not only the center position of the mirror 3042 but also all positions where the actuators or the electrodes for deforming the mirror 3042 are disposed. The unit of measurements in FIG. 7B is mm.

FIG. 7C shows results where the average Zerror_mean and the standard score σ of the correction residual error Zerror are calculated. The unit of measurements in FIG. 7C is mm.

In addition, the magnifications of the first and second imaging optical systems 3041, 3043 in the calculation of the results shown in FIG. 7C are respectively m₁=5, m₂=2. NA (numerical aperture) of the image capturing optical system 304 is 0.7, and the depth of focus is about ±0.5 μm.

The average and the value of 3σ of the standard score σ of the correction residual error shown in FIG. 7C are larger than those in approximate calculation by quadric surface as first embodiment (FIG. 6C), but all points on the surface of the sample are substantially contained within the depth of focus of the image capturing optical system 304. If the undulation of a surface of a sample is not very large, the calculation is usually enough to use the plane approximation as this embodiment.

In each embodiment, the image capturing is performed via the deformable mirror having a shape close to a surface shape of an object, and thereby the image capturing can be performed with high resolution in focusing on an object over a large field of view.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-081928, filed on Apr. 11, 2014, which is hereby incorporated by reference wherein in its entirety.

What is claimed is:

1. An image capturing apparatus configured to perform image capturing an object from its surface side comprising:
an image capturing optical system;
a deformable mirror disposed in an intermediate imaging area of the image capturing optical system; and
a controller configured to divide the object into a plurality of object areas, calculate an approximate surface approximating a surface shape of the object in each of the object areas using shape data indicating the surface shape, and deform the deformable mirror to a shape corresponding to the approximate surface.

2. The image capturing apparatus according to claim 1, wherein the approximate surface is a quadric surface.

3. The image capturing apparatus according to claim 1, wherein the approximate surface is a plane surface.

4. The image capturing apparatus according to claim 1,
wherein an image sensor is disposed on a final imaging plane of the image capturing optical system, and wherein the controller is configured to correct a focus offset by moving the image sensor in an optical axis direction of the image capturing optical system.

5. The image capturing apparatus according to claim 1, wherein the controller is configured to compensate a focus offset by moving the deformable mirror in an optical axis direction of the image capturing optical system.

6. The image capturing apparatus according to claim 1, wherein the controller is configured to compensate a focus offset by moving a second optical system part disposed on an image capturing plane side further than the deformable mirror in the image capturing optical system in a direction orthogonal to the optical axis of the image capturing optical system.

7. The image capturing apparatus according to claim 1, further comprising a focus measurer configured to measure a focus position of the object at a non-capturing area in a field of view of a first optical system part disposed on an object side further than the deformable mirror in the image capturing optical system.

8. A method for performing image capturing of an object from its surface side through an image capturing optical system, the method comprising:
obtaining shape data indicating a surface shape of the object;
calculating an approximate surface approximating the surface shape in each object area using the shape data by dividing the object into a plurality of object areas; and
capturing the image by deforming a deformable mirror to a shape corresponding to the approximate surface, the deformable mirror disposed in an intermediate image area of the image capturing optical system.
